(19) United States
(12) Patent Application Publication
(10) Pub. No.: US 2015/0088729 A1
(43) Pub. Date: Mar. 26, 2015

(54) ONLINE PROPERTY RESERVATION SERVICE PROVIDER FOR RESERVING PROPERTIES FOR LEASE

(71) Applicant: DOMUSO INC., Tarzana, CA (US)

(72) Inventor: Damian Langere, Sherman Oaks, CA (US)

(73) Assignee: DOMUSO INC., Tarzana, CA (US)

(21) Appl. No.: 14/035,879

(22) Filed: Sep. 24, 2013

(51) Int. Cl. G06Q 30/06; G06Q 50/16; G06Q 20/10

(52) U.S. Cl. CPC G06Q 30/0645; G06Q 20/10; G06Q 50/163
USPC 705/39

(57) ABSTRACT

Provided are a computer program product, system, and method for an online property reservation service provider to reserve properties for lease. A computer implemented property reservation service database stores information on rental properties, a hold amount, a cancellation period and an authorization hold period defined for an authorization hold, wherein the authorization hold period is greater than the cancellation period and runs following the cancellation period. A reservation request is received from the renter computer for a reserved property comprising one of the properties and information on a renter financial account. At least one online electronic transaction is initiated to place an authorization hold of the hold amount on the renter financial account for the reserved property in response to the reservation request, wherein the authorization hold maintains the hold amount as unavailable in the renter financial account.

### BACKGROUND OF THE INVENTION

1. Field of the Invention

The present invention relates to a computer program product, system, and method for an online property reservation service provider to reserve properties for lease.

2. Description of the Related Art

Property owners may require that a prospective renter sign a “deposit-to-hold” agreement to have the property manager hold or reserve the property prior to signing the lease agreement to provide the renter a brief amount of time to gather a deposit and first payment and to further consider the property. A deposit-to-hold agreement typically specifies a hold amount and a cancellation period, usually within 24 to 72 hours, during which the prospective renter may cancel the reservation without being charged the hold amount. The renter usually provides the property manager a cashier's check, personal funds, credit card charge or money order for the hold amount. If the cancellation period expires without the renter executing the lease and providing any necessary deposit, then the property manager may deposit the cashier's check, personal funds or money order in the hold amount and cancel the reservation. If the prospective renter completes the lease within the cancellation period, then the money order or check is returned to the renter or applied to any deposit or rent.

To carry out the deposit-to-hold, after deciding to hold the property, the renter has to locate a bank and obtain a cashier's check or money order, which takes time and may not be attainable at the moment if the renter decides to proceed on a weekend or after banking hours. Further, with the current system, the property manager has the administrative burden of securing the cashier's check or money order and depositing in time if the cancellation period expires.

There is a need in the art for improved techniques for reserving a property before the lease is signed.

### SUMMARY

Provided are a computer program product, system, and method for an online property reservation service provider to reserve properties for lease. A computer implemented property reservation service database stores information on rental properties each having at least one unit to lease at the property. The property reservation service database a hold amount, a cancellation period and an authorization hold period defined for an authorization hold, wherein the authorization hold period is greater than the cancellation period and runs following the cancellation period. A reservation request is received from the renter computer for a reserved property comprising one of the properties at which the renter seeks to lease a unit at the reserved property and information on a renter financial account, wherein the reservation request occurs before the lease of the property is signed. At least one online electronic transaction is initiated to place an authorization hold of the hold amount on the renter financial account for the reserved property in response to the reservation request, wherein the authorization hold maintains the hold amount as unavailable in the renter financial account.

### BRIEF DESCRIPTION OF THE DRAWINGS

FIG. 1 illustrates an embodiment of an online property reservation community.

FIG. 2 illustrates an embodiment of property information maintained in a property reservation service database.

FIG. 3 illustrates an embodiment of reservation parameters for an authorization hold.

FIG. 4 illustrates an embodiment of property reservation information maintained in the property reservation service database.

FIG. 5 illustrates an embodiment of renter review information maintained in the property reservation service database.

FIG. 6 illustrates an embodiment of operations to generate and provide a property reservation page for a renter.

FIG. 7 illustrates an embodiment of operations to process a request to initiate the authorization hold.

FIG. 8 illustrates an embodiment of operations to process a request for information from a renter for a reserved property the renter has reserved.

FIG. 9 illustrates an embodiment of operations to process a cancellation request.

FIG. 10 illustrates an embodiment of operations to process a received release code to allow release of the authorization hold.

FIG. 11 illustrates an embodiment of operations to process a request to add a renter to a wait list.

FIG. 12 illustrates an embodiment of operations to process an event where a renter is removed from the reservation list for a property.

FIG. 13 illustrates an embodiment of operations to generate a property manager reservation page for a property.

FIG. 14 illustrates an embodiment of operations to process a reply to the property management reservation page.

FIG. 15 illustrates an embodiment of operations to process an expiration of an authorization hold period for a property.

FIG. 16 illustrates an embodiment of operations to process a request from a property manager for review information for a property.

FIG. 17 illustrates an embodiment of a renter property reservation page.

FIG. 18 illustrates an embodiment of a renter property review page.

FIG. 19 illustrates an embodiment of a renter reservation status page.

FIG. 20 illustrates an embodiment of a property manager reservation page.

FIG. 21 illustrates an embodiment of a property manager review page.

FIG. 22 illustrates an embodiment of a computing environment in which embodiments may be implemented.

### DETAILED DESCRIPTION

Described embodiments provide an online property reservation service to facilitate reservations and authorization holds on properties registered in a property reservation service database. With described embodiments, upon receiving from a renter computer a reservation request for a property, a property reservation service provider places an authorization hold on the renter financial account. The authorization hold may be released in response to the renter computer cancelling the reservation prior to an expiration of a cancellation period. The property manager computer may transfer the hold amount from the renter financial account (referred to as banking the hold) following expiration of the cancellation period and before expiration of an authorization hold period. A property reservation service database may store reservation codes for properties to use to reserve the property. Further, with described embodiments a page may be presented to the renter computer requesting a property review as part of the reservation request processing to collect reviews from prospective renters that were sufficiently committed to the property to reserve the property and have an authorization hold placed on their financial account to reserve the property.

With the described embodiments, the property manager does not have to securely hold a physical renter check for a deposit hold while the reservation is held and the renter does not have to obtain a physical check to present to the property manager and then concern themselves with retrieving the check if they timely cancel the reservation. Instead, the renter may conveniently instantly initiate an authorization hold from a portable computing device, such as a smartphone, to reserve the property, and have all the relevant time periods automatically applied. Further, the renter may conveniently cancel the reservation and release the authorization hold from a computing device prior to the expiration of the cancellation period. The property manager may also use a computing device, such as a smartphone or computer, to conveniently manage property reservations, release authorization holds for reservations and bank reservation holds without having to manage checks and paperwork from the renter, and without having to take the time to physically return the renter checks for the authorization hold.

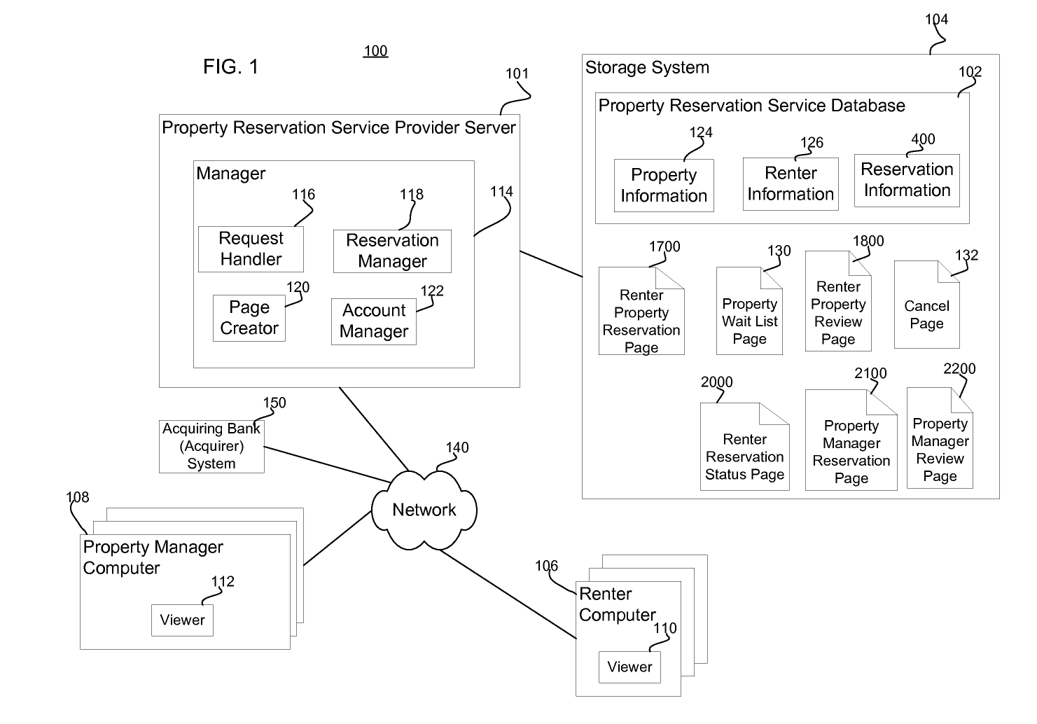

FIG. 1 is an embodiment of an online property reservation community 100 for facilitating a reservation for a rental property including a property reservation service provider (“PRSP”) server 101 that accesses a property reservation service database 102 implemented in a storage system 104 to allow property managers at property manager computers 108 to register properties having rental units with the property reservation service database 102 and to allow renters at renter computers 106 to reserve the property and initiate an authorization hold on their financial account to reserve the property in the property reservation service database 102. A property manager comprises a person authorized to perform leasing duties for the property, including, but not limited to deposit-to-holds for the property, such as an owner, leasing agent, property manager, etc., and a renter comprises a person seeking to rent a unit at a property. The property may be any property for lease, such as a single family home, apartment, within a building or home.

The authorization hold initiated as part of the reservation request through the PRSP server 101 may comprise an authorization hold placed on the renter financial account to authorize the property manager to charge the hold amount if the renter does not sign the lease within a cancellation period. The renter financial account may comprise any account on which an authorization hold may be placed, such as a credit card, debit card, etc.

During the cancellation period, the renter or property manager may release the authorization hold to cancel the reservation so that the hold amount is not charged. During an authorization hold period, which follows the cancellation period, the property manager may bank the hold amount, which causes an electronic online transaction to transfer the hold amount from the renter financial account to the property manager financial account if the renter did not execute the lease nor cancel within the cancellation period. In certain embodiments, after the authorization hold period has expired, the authorization hold on the renter financial account may automatically be released to make the hold balance available again in the renter financial account. The authorization hold period may be longer than the cancellation period. For instance, the cancellation period may extend for 24 to 72 hours and the authorization hold period may extend for 30 days. Further, the authorization hold period may correspond to the time at which the authorization hold automatically falls off the account.

Each renter computer 106 and property manager computer 108 includes a viewer program 110 and 112, respectively, to render a graphical user interface (GUI) to enable the renters and property managers to access pages of information on rental properties and accounts from the server 101. The viewer program GUI 110 and 112 may comprise an Internet web browser, an email program, a text message program cable of rendering Short Message Service (SMS), Multimedia Messaging Service (MMS) messages, a proprietary application or program, etc.

The server 101 includes a manager 114 having program components to implement property reservation service operations, including a request handler 116 to handle requests from the renter 106 and property manager 108 computers; a reservation manager 118 to manage reservation requests, authorization holds and leasing related operations; a page creator 120 to manage the creation of pages having information on property rentals and deposit hold transactions to return to the renter 106 and property manager 108 computers; and an account manager 122 to create and manage accounts in the online property reservation community 100 for renters and properties.

The property reservation service database 102 may include property information 124 having information on registered properties having rental units available to lease and renter information 126 having information on renter accounts such as contact information, credit rating, income, profile information, such as personal and professional, etc., financial account information identifying a financial account the renter has authorized to be used for authorization holds, where the renter financial account is capable of having an authorization hold placed, such as a credit card or debit card. The database 102 may further include reservation information 400 having information on reservations resulting in authorization holds on renter financial accounts.

The property reservation service provider would contract with an acquiring bank, also known as an acquirer, that processes credit and debit card payments for the property reservation service provider. An acquirer system 150 comprises an online computer system which the property reservation service provider server 101 communicates with over the network 140 to place authorization holds and charges on renter financial accounts maintained at the credit or debit card issuing bank that maintains the renter's financial account, e.g., credit or debit card.

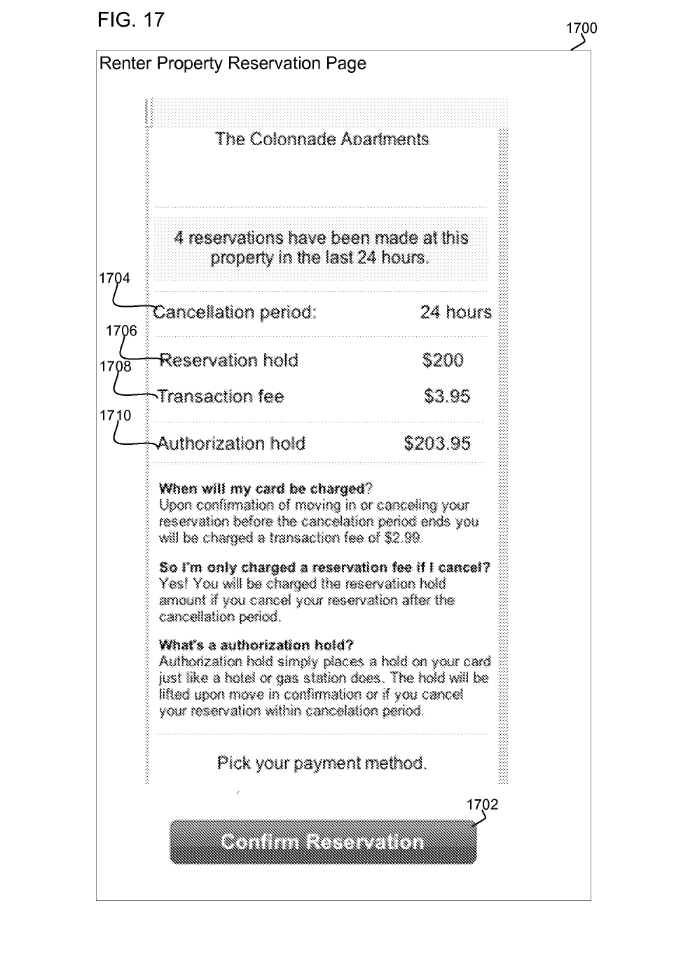

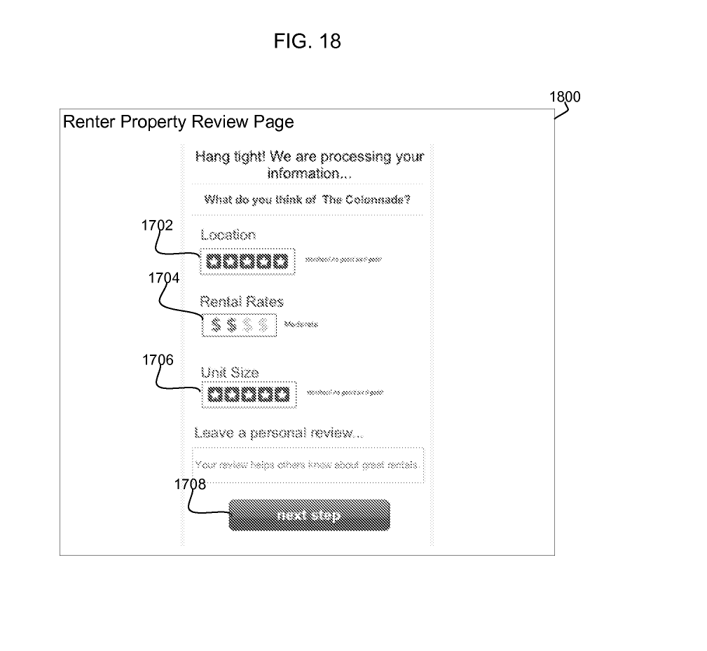

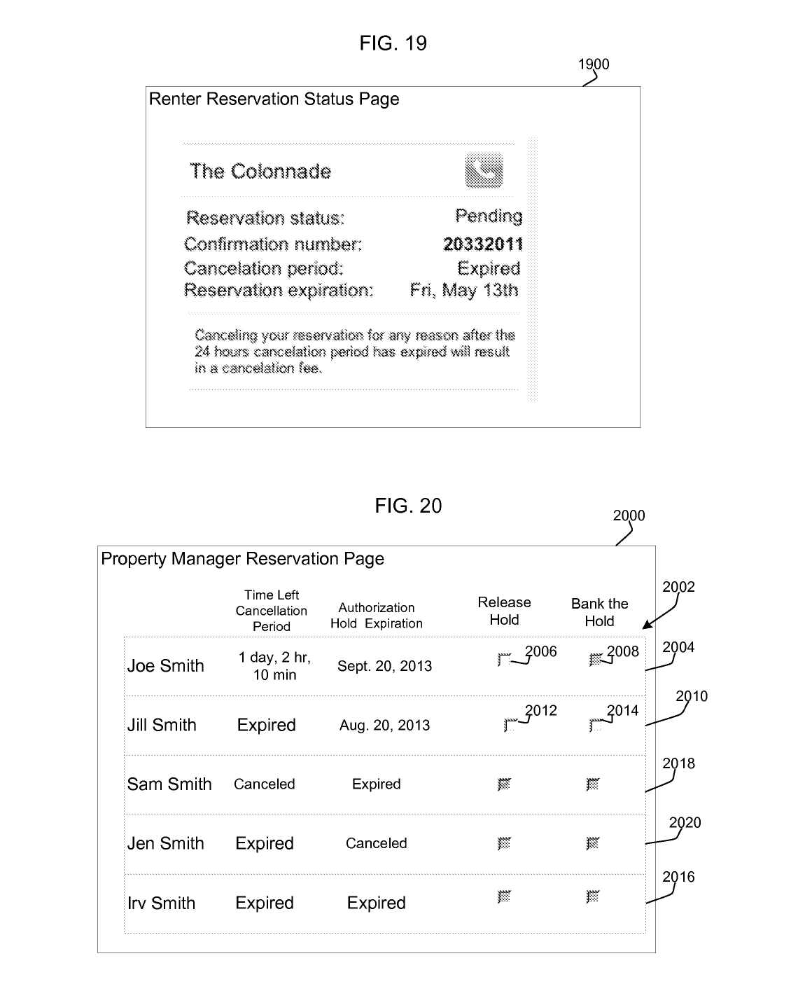

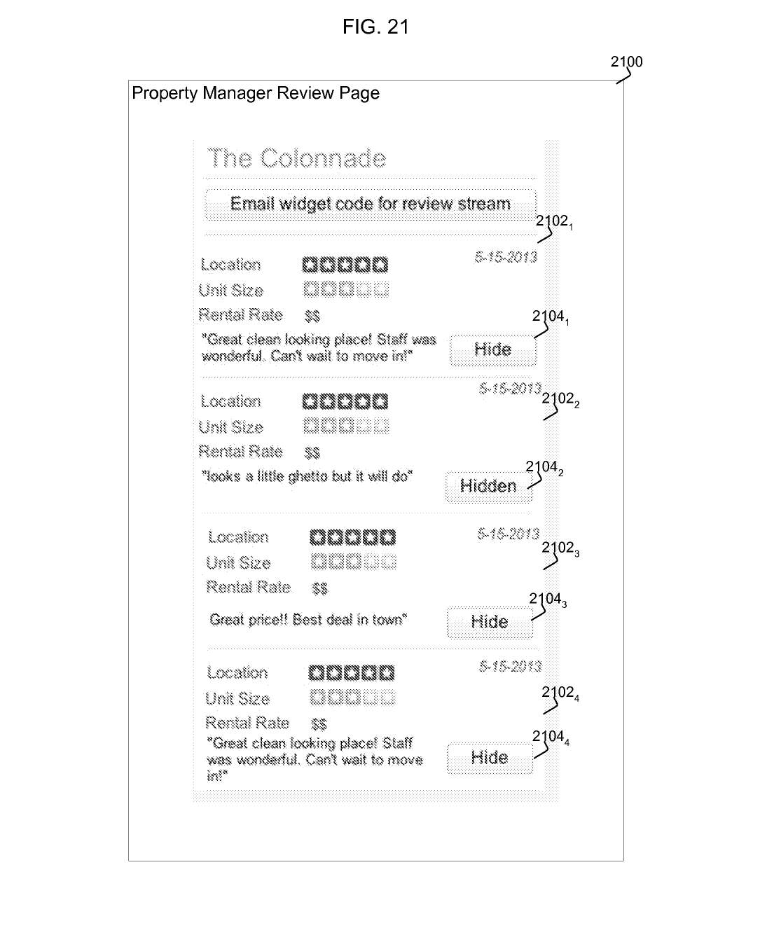

The page creator 120 generates pages of information for the renter 106 and property manager 108 computers from page forms including a renter property reservation page 1700 (FIG. 17) provided to renter computers 106 to enable renters to reserve a property with an authorization hold on the renter financial account prior to signing the lease; a property wait list page 130 enabling the renter to be added to a wait list if they cannot reserve the property; a renter property review page 1800 (FIG. 18) enabling the renter to review the property subject to the reservation; a renter reservation status page 1900 (FIG. 19) to provide the renter information on their reservation; a property manager reservation page 2000 (FIG. 20) to enable the property manager to review the status of reservations and cancel or bank the authorization hold; and a property manager review page 2100 (FIG. 21) to enable the property manager to manage renter reviews for a property.

The pages 130, 1700, 1800, 1900, 20000, 2100, and 2200 may be encoded as a computer renderable page, such as web page using a document markup language to provide content and formatting, such as Hypertext Markup Language (HTML), Extended Markup Language (XML), extensible HTML (XHTML), dynamic HTML (DHTML) or encoded using other document coding languages and techniques known in the art. The pages may be encoded for different operating environments, such as a smartphone, desktop, tablet computer, etc.

The PRSP server 101, storage system 104, database 102, renter computer 106, and property manager computer 108 may be implemented in one computer system or in distributed computing systems distributed across the network 140. In further embodiments, any of the server 101, database 102, and storage system 104 may be implemented in one or more computing devices accessible over a network 140.

In certain embodiments, the renter 106 and property manager 108 computers may comprise laptop computers, desktop computers, smartphones, tablet computers or any other suitable computational device known in the art.

The database 102 may be comprised of one or more database servers and databases, such as distributed databases, heterogeneous databases, etc., including information to implement the online property reservation community.

The network 140 may comprise a Local Area Network (LAN), the Internet, Storage Area Network (SAN), Wide Area Network (WAN), wireless network, etc. The server 101 may comprise one or more enterprise servers, mainframes, servers, etc., and the renter 106 and property manager 108 computers may each comprise a server, desktop computer, workstation, laptop, smart phone, tablet computer, telephony device, personal digital assistant (PDA), etc., or other suitable computing device.

The storage system 104 may comprise one or more suitable storage devices, such as interconnected hard disk drives (e.g., configured as a DASD, RAID, JBOD, etc.), solid state storage devices (e.g., EEPROM (Electrically Erasable Programmable Read-Only Memory), flash memory, Solid State Devices (SSD), flash disk, storage-class memory (SCM)), electronic memory, magnetic tape media, tape cartridges, etc.

The manager 114 components and the viewer 112 may comprise software programs loaded in a memory and executed by a processor. In alternative embodiments, some portion or all of the manager 114 and viewer 112 components may be implemented in a hardware device, such as a dedicated integrated circuit, e.g., Application Specific Integrated Circuit (ASIC), expansion card, etc.

The online property reservation community 100 may be implemented in a cloud computing environment.

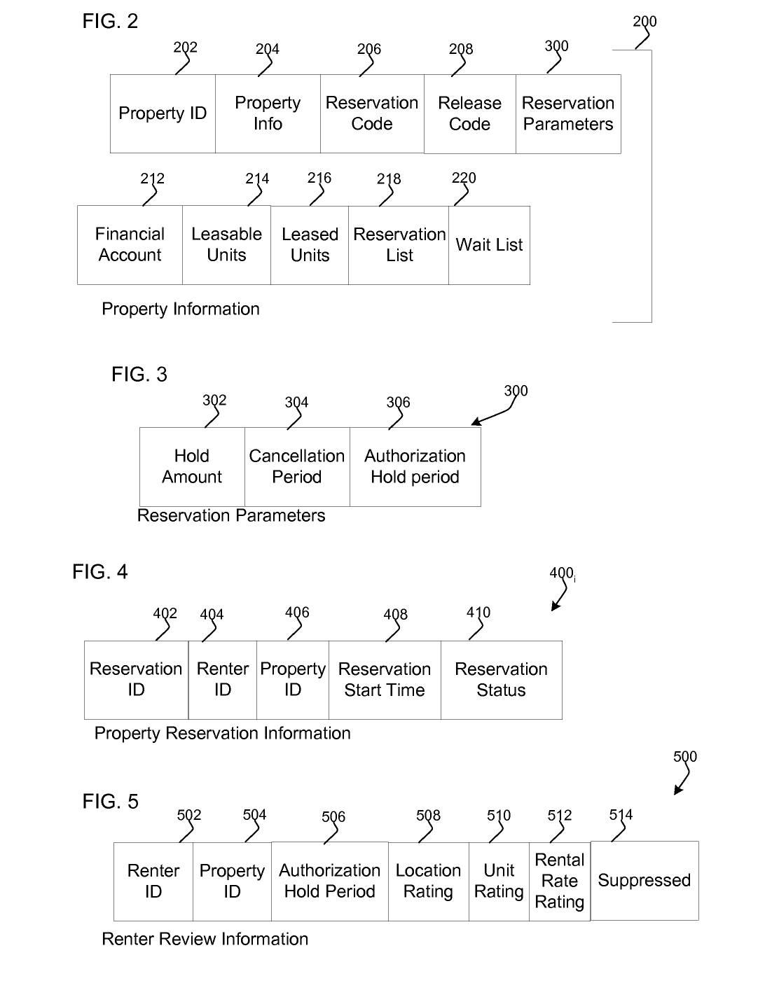

FIG. 2 is an embodiment of property information 200 for one property maintained in the property information 124, which would be created by the property manager. The property information 200 includes a unique property identifier 202; property information 204, such as address, neighborhood, contact information, descriptive information, etc.; a reservation code 206 associated with the property 202 that is used by renters and the property manager to identify the property; a release code 208 that the property manager or renter may use to release the authorization hold after the cancellation period has expired; reservation parameters 300 providing configurable settings for the reservation; financial account information 212 providing information on a property manager financial account to use for lease related operations; the number of leasable units 214 at the property 202; the number of leased units 216 no longer available; a reservation list 218 identifying active reservations by renters; and a wait list 220 identifying renters on a wait list waiting to reserve the property 202 and initiate an authorization hold.

The property information 200 may be generated when the property manager creates the information for the property 200, such that the reservation manager 118 generates a reservation code 206 and release code 208 when the property manager creates the property information in the property reservation service database 102.

FIG. 3 is an embodiment of the reservation parameters 300 for a reservation. These parameters 300 may be configured by the property manager or the property reservation service provider who maintains the server 101 and database 102. The reservation parameters 300 include a hold amount 302 of the amount of the authorization hold on the renter financial account; a cancellation period 304 during which the renter may cancel the authorization hold without being charged the hold amount 302; and an authorization hold period 306 during which the authorization hold is maintained.

FIG. 4 illustrates an embodiment of an instance 400ᵢ of the reservation information 400 for one reservation. The reservation information instance 400, may include a reservation ID 402 providing a unique identifier of the reservation; a unique renter identifier (ID) 404 of the renter requesting the reservation; a property ID 406 of the reserved property subject to the reservation; a reservation start time 408 indicating a time the reservation was placed on the reserved property; and a reservation status 410 indicating a current status of the reservation, such as authorization hold active, authorization hold released, hold amount transferred, cancellation period expired, authorization expired, etc. If the renter cancels within the cancellation period 304, the authorization hold is released. If the property manager/owner cancels following expiration of the cancellation period and before expiration of the authorization hold period 306, then the hold amount 302 is transferred from the renter financial account to the property manager financial account through the acquirer system 150 which acquires credit card payment from the card-issuing bank of the renter financial account.

In certain embodiments, the property manager may further charge through the online property reservation service provider an application fee (e.g., $20) and the online property reservation service provider may further charge an additional processing fee (e.g., $3). Further, a renter may fill out an application for a rental unit and pay the application fee (e.g., $20) without requesting a reservation and initiating the authorization hold.

FIG. 5 is an embodiment of renter review information 500 that one of the renters has provided for one of the properties when reserving the property. The renter review information 500 instance may be maintained in the renter information 126 in the database 102. Thus, the renter review information 500 is for a property which the renter sufficiently approved to reserve the property. The renter review information 500 includes the renter ID 502, such as one of the renter IDs 402 (FIG. 4) and a property ID 504 for which the review is provided; an authorization hold period 506 when the reservation occurred; a location rating 508 providing the renter review of the location of the property; a unit rating providing a review of a characteristic of the unit, such as overall impression, size, etc.; a review of the rental rate 512; and a suppression field 514 indicating whether the property manager selected to suppress this review so it is not presented to renters requesting reviews for properties.

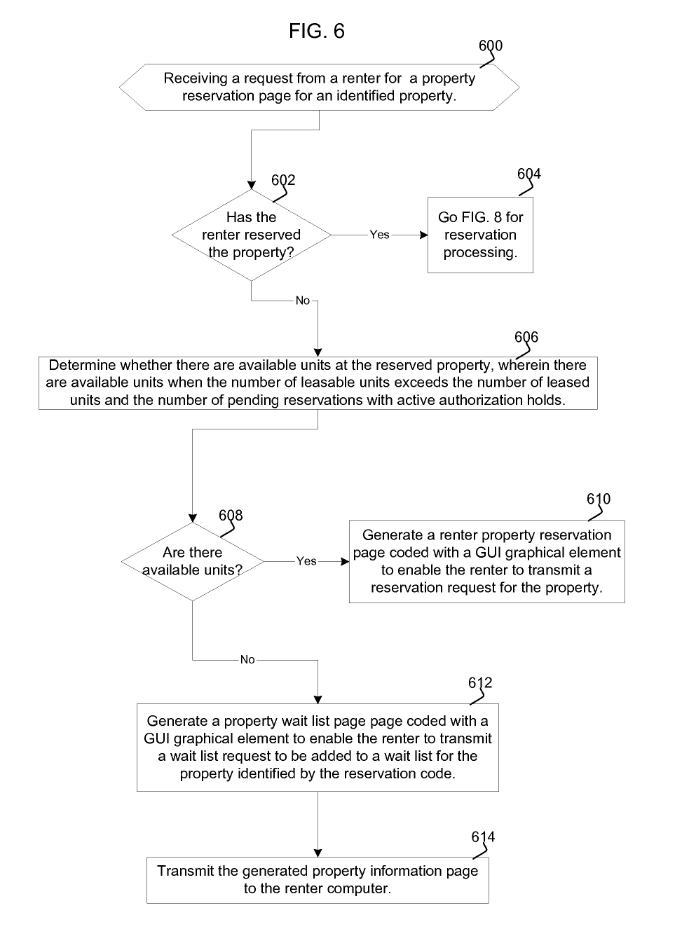

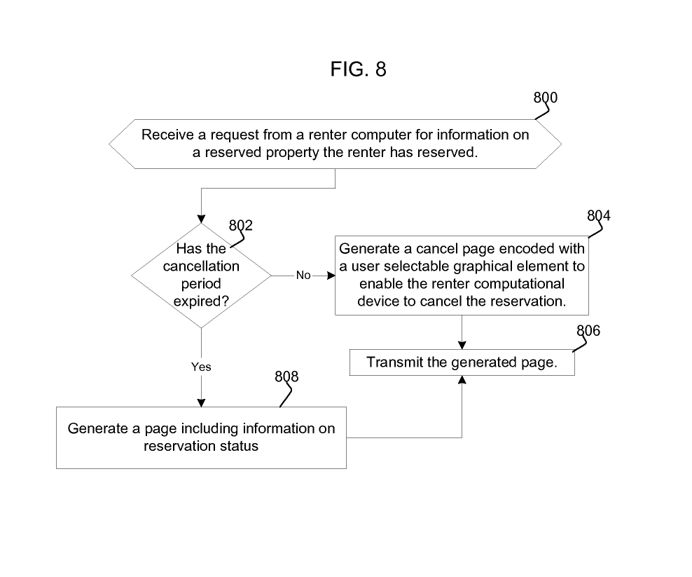

FIG. 6 illustrates an embodiment of operations the server 101 and manager components 114, including the reservation manager 118 and page creator 120, perform to respond to a request for a property reservation page from a prospective renter presenting a property reservation code 206 for a registered property. Upon receiving (at block 600) a request for information for a property identified by reservation code 206 (FIG. 2), the reservation manager 118 determines (at block 602) whether the prospective renter has a reservation 400, for the requested property identified by the reservation code 206. If yes, control proceeds (at block 604) to FIG. 8 for reservation processing. If (at block 602) the requesting renter does not have a reservation 400, for the property identified by the reservation code 206, then the reservation manager 118 determines (at block 606) whether there are available units at the reserved property. There are available units when the number of leasable units 214 exceeds the number of leased units 216 and the number of active reservations or authorization holds indicated in the reservation list 218. If (at block 608) there are available units, then the leasing manager 118 calls the page creator 120 to generate (at block 610) a renter property reservation page 1700 (FIG. 17) coded with a GUI graphical element, e.g., a confirmation reservation button 1702, to enable the prospective renter to transmit a request to confirm the reservation for the property and place an authorization hold for the identified property. As shown in FIG. 17, the reservation page 1700 may further include information on the cancellation period 1704, the amount of the authorization hold 1706, a transaction fee charged 1708, and the total amount of the authorization hold 1710 to be placed on the renter financial account 406.

If (at block 608) there are no available units, then the page creator 120 generates a property wait list page 130 coded with a GUI graphical element to enable the prospective renter to transmit a request to be added to the wait list 220 for the property identified by the reservation code 206. The leasing manager 118 may then transmit the generated page 1700 or 130 to the renter computer 106 to be rendered in the renter viewer 110.

In alternative embodiments, upon receiving a reservation request when the requesting renter has not already reserved the property, the reservation manager 118 may not determine whether there are available units at the property and instead provide the renter property reservation page 1700 to allow the renter to reserve the property and have the authorization hold placed on the renter financial account. This would allow the property manager to stack reservations and take more reservations than available units at the property.

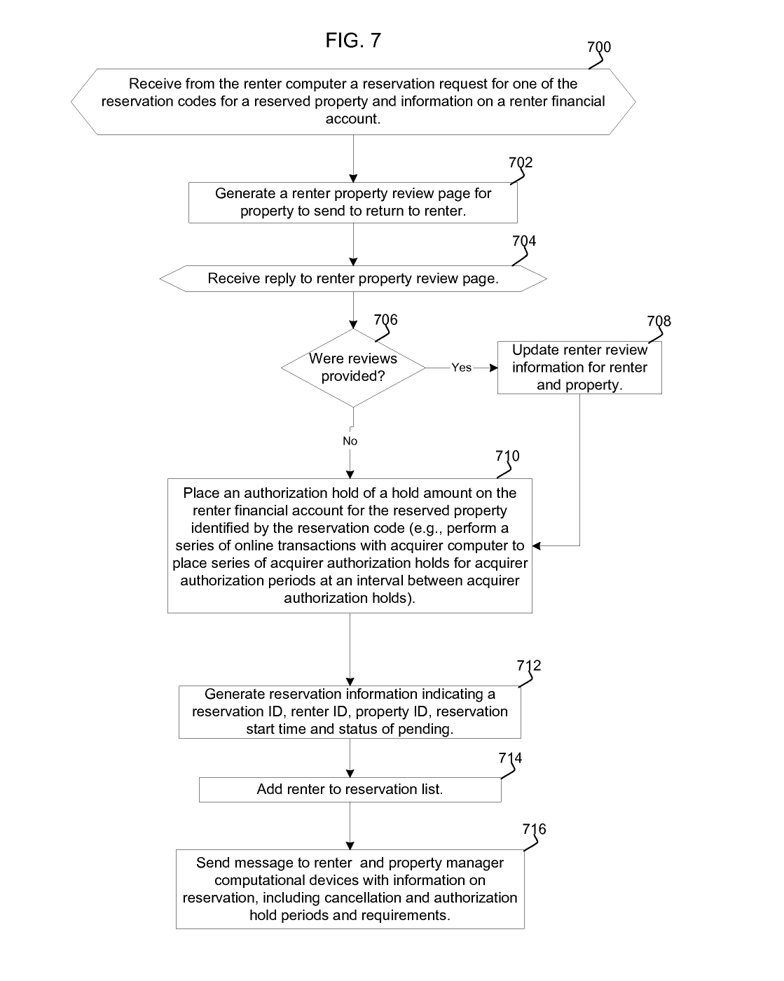

FIG. 7 illustrates an embodiment of operations performed by the manager components 114, such as the request handler 116, reservation manager 118, and page creator 120 to process a renter request to reserve a property. Upon receiving (at block 700) a reservation request, which may be transmitted when the renter selects the confirmation reservation button 1702 from the renter property reservation page 1700, the leasing manager 118 invokes the page creator 120 to generate (at block 702) a renter property review page 1800 (FIG. 18) in which the renter may review the property. As shown in FIG. 18, the renter property review page 1800 includes user selectable fields in which the renter initiating the reservation may rate, by way of example, the property location 1802, rental rate 1804, and unit size 1806, and a next step button 1808 to transmit the review and proceed with the deposit hold processing. The reservation manager 118 may then transmit the generated page 1800 to the renter computer 106.

Upon the server 101 receiving (at block 704) a reply to the renter property review page 1800, if (at block 706) there were reviews provided, as opposed to being left blank, then the leasing manager 118 updates (at block 708) the renter view information 500 with the provided reviews for location 508, unit 510, and rental rate 512 (FIG. 5). If (at block 706) reviews were not provided or after they are updated (at block 716), then the leasing manager 118 may place (at block 710) an authorization hold of the hold amount 302 on the prospective renter financial account for the reserved property identified by the reservation code 206. In certain embodiments, the acquirer implements the authorization holds, such as done by AUTHORIZE.NET® (AUTHORIZE.NET is a registered trademark of InfoSpace, Inc.).

In certain embodiments, the authorization hold period 306 for the reservation may exceed the authorization hold the acquirer (e.g., acquiring bank) permits, i.e., the acquirer authorization hold, for the property reservation service provider. In such case, the reservation manager 118 may implement a reservation authorization hold period 306 at block 710 in FIG. 7 by initiating a plurality of online transactions with the acquirer computer system 150 to place multiple acquirer authorization holds for an acquirer authorization hold period, wherein the authorization hold period 306 for the reservation is a multiple of the acquirer authorization hold period. For instance, if the acquirer bank can only obtain an acquirer authorization hold of three days and the authorization hold period 306 for the reservation is thirty days, then the reservation manager 118 would initiate online financial transactions with the acquirer computer system 150 to place ten acquirer authorization holds, one every three days but before the current acquirer authorization hold expires to maintain an authorization hold for the entire reservation authorization hold period 306. In this way, there is an interval between each of the plurality of initiated online transactions for the acquirer authorization hold such that the interval is slightly less than the acquirer authorization hold period. Having the interval slightly less than the acquirer authorization hold period ensures a new acquirer authorization hold is initiated before the current acquirer authorization hold expires to avoid there being a lapse in the authorization hold on the renter financial account for any time period during the reservation authorization hold period 306.

Reservation information 400, is generated (at block 712) including a reservation ID 402, renter ID 404, property ID 406, a reservation start time 408 which may comprise a time the reservation request was received or when the authorization hold was placed, and a reservation status 410 of pending. The renter is added (at block 714) to the reservation list 218 for the property. Messages may be sent to the renter 106 and property manager 108 computers with information on the authorization hold, including cancellation and authorization hold periods and requirements.

With the described embodiments for generating reviews, property managers can be assured that reviews will be by those who have a likely positive perspective of the property because the reviews are written by those who have reserved the property and initiated an authorization hold on their financial account. Property managers may also be assured that reviews will tend to be more favorable given that the renter was sufficiently satisfied with the property to make the reservation. This addresses a substantial concern in the property management community with negative reviews on properties placed by current tenants or people that did not decide to commit to the property. With the review system of the described embodiments, reviews will tend to be provided by those not having a predisposed animus toward the property or property owners because the review is provided as part of the reservation processed when the renter was sufficiently content to commit to reserving a property with an authorization hold.

FIG. 8 illustrates an embodiment of operations performed by the manager components 114, such as the request handler 116, reservation manager 118, and page creator 120, to process an information request for a property identified by a reservation code 206 from a renter identified as having a pending reservation 400, on the property. Upon receiving (at block 800) such an information request, if (at block 802) the cancellation period 304 has not expired, for instance the time from the reservation start time 408 to the current time does not exceed the cancellation period 304, then the reservation manager 118 calls the page creator 120 to generate (at block 804) a cancelation page 132 coded with a user selectable graphical element to enable the renter through the renter computer 106 to cancel the reservation, e.g., a cancel reservation button.

If (at block 802) the cancellation period has expired, for instance the time since the reservation start time 408 to the current time does exceeds the cancellation period 304, then the page creator 120 is called to generate (at block 808) a status page 2000 (FIG. 20) including information on the reservation status, including information on the time remaining in the authorization hold period, etc. The generated page 2000 or 132 is transmitted (at block 806) to the renter computer 106.

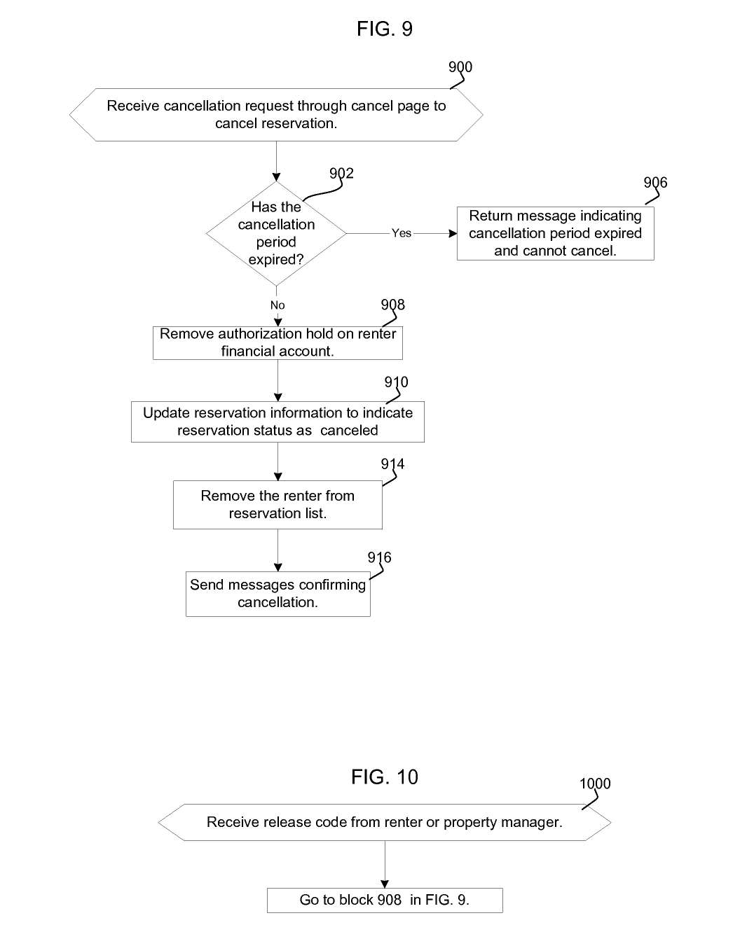

FIG. 9 illustrates an embodiment of operations performed by the manager components 114, such as the request handler 116, reservation manager 118, and page creator 120, to process a cancellation request from a renter transmitted through the cancellation page 132 to cancel an identified reservation. Upon receiving (at block 900) the cancellation request, if (at block 902) the cancellation is received or initiated outside of the cancellation period, i.e., the cancellation period has expired, then a message is returned (at block 906) indicating the cancellation period has expired and the renter cannot release the authorization hold. Otherwise, if the cancellation period did not expire, then the reservation manager 118 communicates with the financial institution of the renter financial account online to remove (at block 908) the authorization hold and updates (at block 910) the reservation information 400, to indicate the reservation status 410 is canceled by the renter. The renter may then be removed (at block 914) from the reservation list 218 for the property 202 and messages are sent (at block 916) to the renter 106 and property manager 108 computers confirming the renter cancellation.

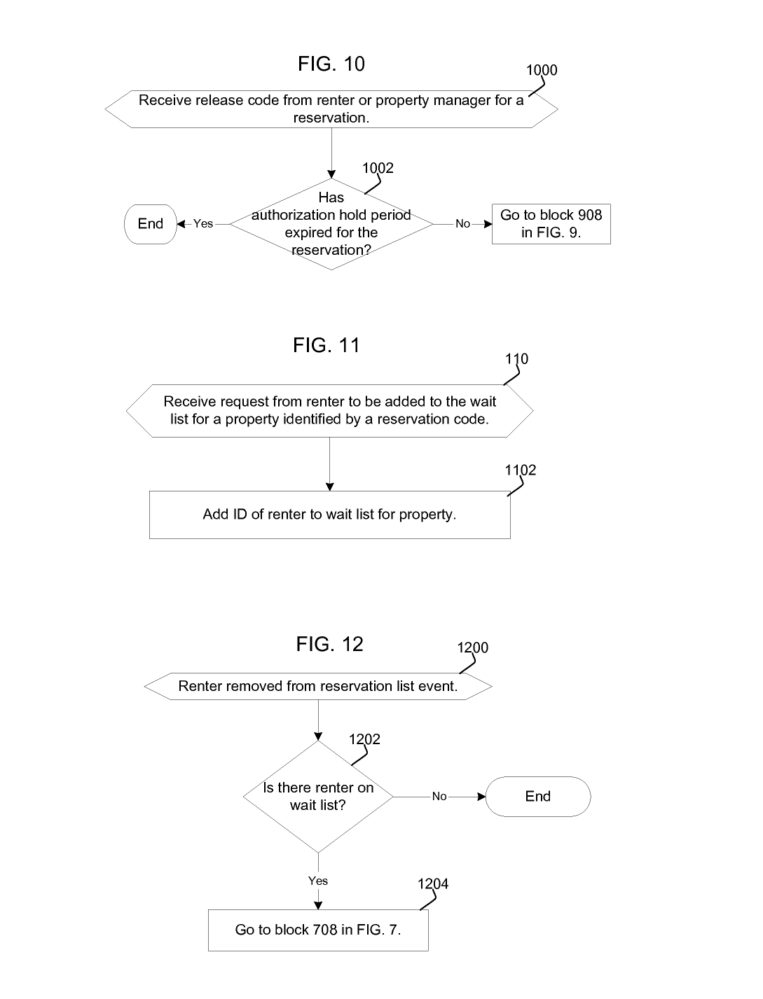

FIG. 10 illustrates an embodiment of operations performed by the reservation manager 118 upon receiving (at block 1000) the release code 208 for a reserved property from the renter 106 or property manager 110 computers. In response to this code 208, if (at block 1002) the authorization hold period has not expired, then the cancellation operations at blocks 906, 908, 910, 914, and 916 in FIG. 9 are performed to cancel the reservation. If the authorization hold period has expired (from the yes branch of block 1002), then control ends without implementing the cancellation. The property manager may, in their discretion, use or provide the release code 208 to the renter to allow the code 208 to be transmitted to the server 101 to release the authorization hold after the cancellation period has expired and before expiration of the authorization hold period. Further, the property manager may use the release code 108 to cancel the authorization hold within the cancellation period. In this way, the property manager may override the system to cancel or release the authorization and reservation hold for whatever business reason.

FIG. 11 illustrates an embodiment of operations performed by the reservation manager 118 in response to receiving (at block 1100) a request from the renter computer 106 to be added (at block 1102) to the wait list 220 for a property identified by a reservation code 206. In response to this request, the renter ID of the requesting renter is added to the wait list 220 for the identified property.

FIG. 12 illustrates an embodiment of operations performed by the reservation manager 118 in response to a renter being removed from the reservation list 218 for a property as a result of a cancellation or expiration of the authorization hold period or move-in. Upon a renter being removed (at block 1200), if (at block 1202) there is no renter on the wait list 220, then control ends. Otherwise, if there is a renter on the wait list 220, then control proceeds (at block 1204) to block 706 et seq. in FIG. 7 to create a reservation 400 for the renter at the top of the wait list 220.

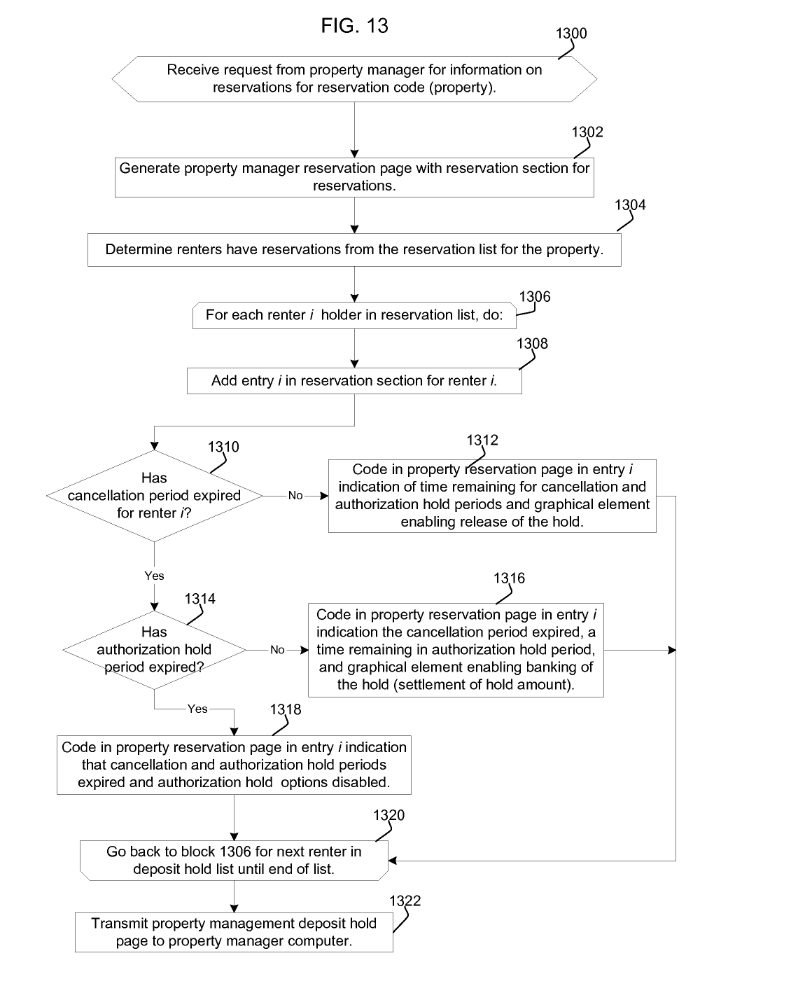

FIG. 13 illustrates an embodiment of operations performed by the manager components 114, such as the request handler 116, reservation manager 118, and page creator 120, to process a request from the property manager computer 108 for information on reservations for a property identified by a reservation code. In response to such request (at block 1300), a property manager reservation page 2000 (FIG. 20) is generated with a reservation section 2002 for reservations. A determination is made of the renters having reservations from the reservation list 218 for the requested property. For each renter i in the reservation list 218 a loop (at block 1306-3120) of operations 1308 through 1318 are performed. At block 1308, an entry i in the reservation section 2002 is added for a renter, e.g., Joe Smith, Jill Smith, Sam Smith, etc. If (at block 1310) the cancellation period has not expired for renter i, then the reservation manager 118 codes (at block 1312) in the section 2002 for entry i information of a time remaining for cancellation and authorization hold periods and a graphical element 2006 enabling invocation of an electronic transaction to release the hold as shown in entry 2004 in FIG. 20. The “bank the hold” 2008 graphical element enables invocation of an electronic transaction to settle the authorization hold and cause the transfer of the hold amount 302 from the renter financial account to the property manager financial account 212. In entry 2004, the “bank the hold” checkbox 2008 is shown as disabled because the cancellation period has not expired, so this option is not yet available.

If (at block 1310) the cancellation period has expired and if (at block 1314) the authorization hold period has not expired, then the leasing manager 118 codes (at block 1316) in property reservation page 2000 in entry i indicating the cancellation period expired, a time remaining in the authorization hold period, and a graphical element 2014 enabling invocation of an electronic transaction to bank the hold and another graphical element 2012 enabling invocation of an electronic transaction to release the hold as shown in entry 2010, having the “bank the hold” graphical element 2014 shown as enabled because the cancellation period expired and having the “bank the hold” graphical element 2014 enabled because the authorization hold period has not expired.

If at (block 1314) the authorization hold period has expired, then entry i is coded (at block 1318) to indicate that the release and “bank the hold” options are disabled as shown in entry 2016 in FIG. 20. The entries 2018 and 2020 show that the authorization hold was released and that the hold was banked, respectively.

After coding the property manager reservation page 2000, the generated page 2000 is transmitted to the property manager computer 108.

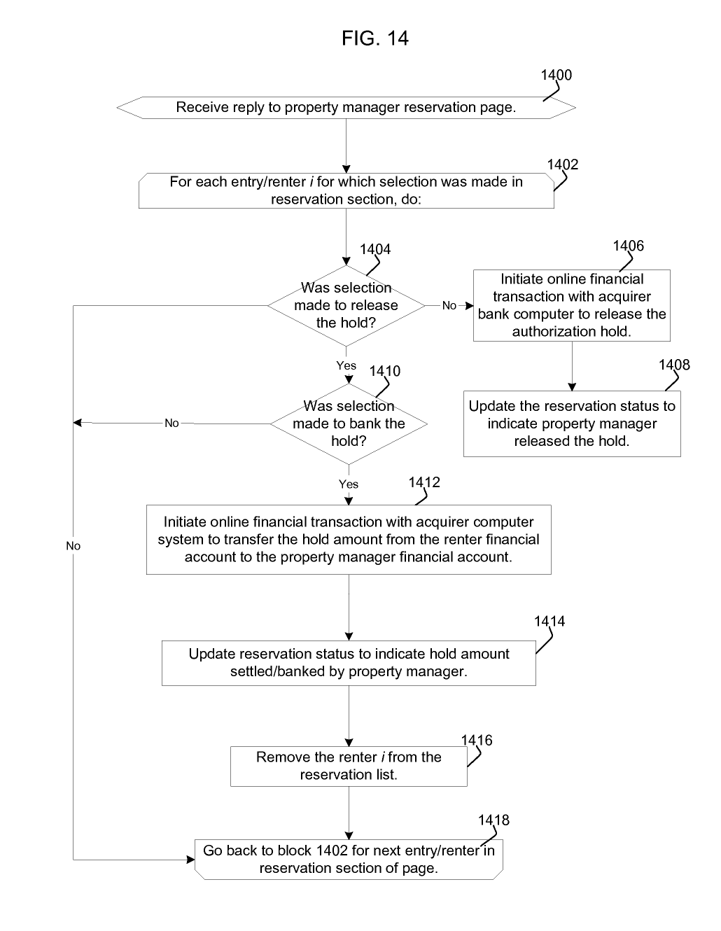

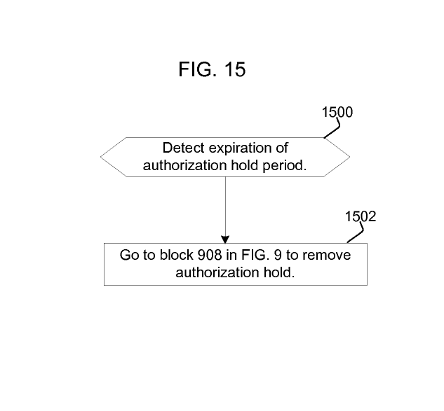

FIG. 14 illustrates an embodiment of operations performed by the manager components 114, such as the request handler 116, reservation manager 118, and page creator 120, to process a reply to the property management reservation page 2000 from the property manager computer 108. Upon receiving (at block 1400) the reply, a loop (at block 1402 through 1418) of operations 1404 to 1416 is performed for each entry/renter i for which selection was made in the reservation section 2100. If (at block 1404) the property manager selected to release the authorization hold for the renter/entry i, prior to the authorization hold period expiring, then an online financial transaction with the acquirer computer system 150 is initiated (at block 1406) to release the authorization hold and the reservation status 410 for the reservation is updated (at block 1408) to indicate that the property manager released the authorization hold.

If (at block 1410) the property manager selected to bank the hold, then an online financial transaction is initiated (at block 1412) with the acquirer computer system 150 to settle the authorization hold and transfer the hold amount from the renter financial account to the property manager financial account. The reservation status 410 is updated (at block 1414) to indicate that the authorization hold amount was banked or transferred to the property manager financial account. The renter i is removed (at block 1416) from the reservation list 218.

FIG. 15 illustrates an embodiment of operations performed by the reservation manager 118 upon detecting (at block 1500) an expiration of the authorization hold period for a reservation, as determined from the reservation start time 408. Upon detecting the expiration, control proceeds (at block 1502) to block 908 et seq. in FIG. 9 to remove the authorization hold for the renter.

In certain described embodiments, if no action has been taken prior to the expiration of the authorization hold period, then the system may assume the move-in occurred at the reserved property and the authorization hold is removed because the property manager did not proactively cancel the reservation upon learning the lease would not be timely signed. In other embodiments or implementations, other actions may occur upon expiration of the authorization hold period, such as contacting the property manager to confirm the reservation was canceled.

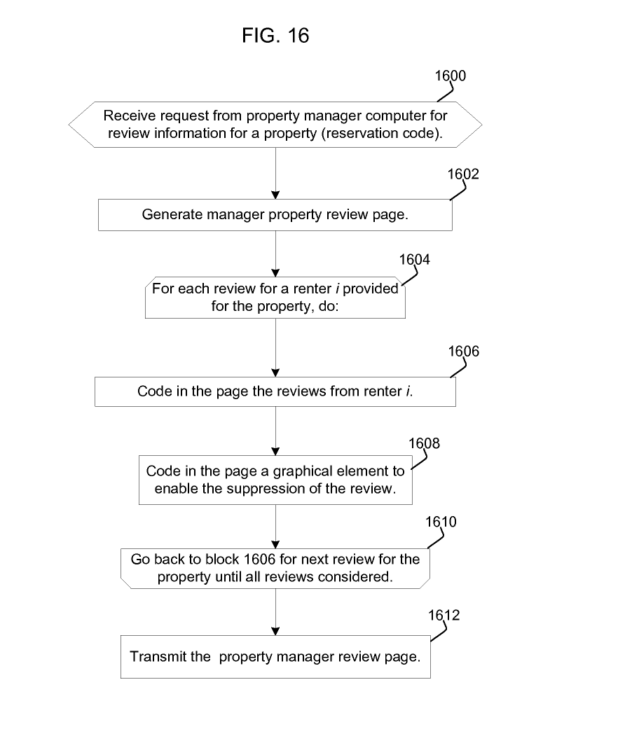

FIG. 16 illustrates an embodiment of operations performed by the manager components 114, such as the request handler 116, reservation manager 118, and page creator 120, to process a request from the property manager computer 108 for a property manager review page 2100 (FIG. 21) to allow the property manager to manage the reviews for a property. Upon receiving (at block 1600) the request, the page creator 120 is invoked to create the property manager review page 2100. A loop (at block 1604 through 1610) of operations 1606 through 1608 is performed for each renter i having review information instance 500 for a property, identified in the property ID 504 field. The review for renter i is coded in the page 2100. For instance, in FIG. 21, there are entries 2102₁, 2102₂, 2102₃, 2102₄ for reviews provided by different renters for the property that initiated a deposit hold. The page creator 120 is invoked to further code (at block 1608) a graphical element 2104₁, 2104₂, 2104₃, 2104₄ for entry i to enable the suppression of the review. The property manager review page 1612 is transmitted to the property manager computer 108 to process.

Graphical element 2104₂ provides an example of where the property manager has selected to hide the review 2102₃ in the property manager review page 2100, resulting in the button label “Hidden” instead of “Hide”. Upon receiving the property manager reply to the page 2100 with selection of reviews to hide, the reservation manager 118 may update the suppression field 514 to indicate the review is suppressed and would not be returned to a renter requesting review information for a property. In this way, the property manager has control to remove reviews they find unhelpful or unfair. Upon receiving a request from a renter for property reviews for a property, the reservation manager 118 may generate a cumulative review for the reserved property comprising an aggregation of individual reviews from prospective renters in the property reservation service database that are not indicated as suppressed. In certain embodiments, the reviews may be weighted such that more recent reviews are provided a higher weighting than older reviews to bias the reviews to more recent reviews which more accurately reflect the current state of the property.

Further, the property manager may access a graphical user interface dashboard to view ratings and filter reviews based on metrics such as a time stamp, property code being reviewed, and region.

Described embodiments provide an online property reservation service provider to facilitate and manage the reservation of properties and application of an authorization hold on the renter reserving the property before the lease is signed and to provide a process to manage the charging and releasing of the authorization hold. Described embodiments provide for the placement of an authorization hold upon the renter financial account in response to a reservation request, releasing the authorization hold in response to the renter computer requesting cancellation, and charging/banking the hold amount in response to the property manager computer selecting to bank the hold amount between the expiration of a cancellation period and the authorization hold period. Further, with described embodiments, the property review process is incorporated into the reservation process and the property manager is provided an opportunity to selectively disable property reviews from being presented to users in the online property reservation service community 100.

In described embodiments, a transaction fee substantially less than the hold amount is charged to the renter financial account when the reservation occurs, such as an application fee. Further, at the time the reservation request is received, a fee may also be charged to the renter and transferred to a financial account of the online property reservation service provider. Thus, the property reservation service provider facilitates reservation of properties by providing an automated process for allowing the renter to reserve a property and provide an authorization hold that the property manager may bank if the renter does not sign the lease and move-in to the property by the end of the cancellation period.

### CONCLUSION

The described operations may be implemented as a method, apparatus or computer program product using standard programming and/or engineering techniques to produce software, firmware, hardware, or any combination thereof. The described operations may be implemented as code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmission signals. Those skilled in the art will recognize that many modifications may be made to this configuration without departing from the scope of the present invention, and that the article of manufacture may comprise suitable information bearing medium known in the art.

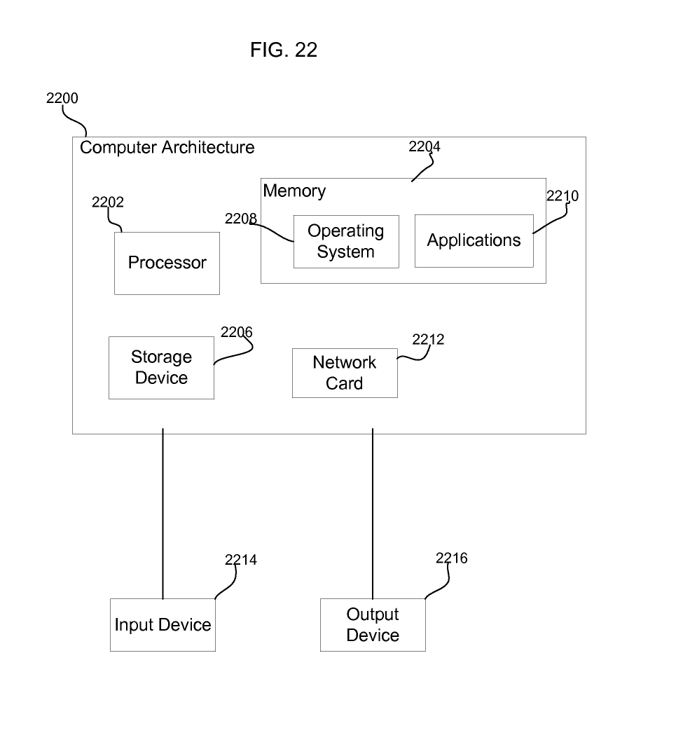

FIG. 22 illustrates an implementation of a computer architecture 2200 that may be implemented at the server 101, storage system 104, renter 106, property manager 108, and the acquirer 150 computers. The architecture 2200 may include a processor 2202 (e.g., one or more microprocessors and cores), a memory 2204 (e.g., a volatile memory device), and storage 2206 (e.g., a non-volatile storage, such as magnetic disk drives, solid state devices (SSDs), optical disk drives, a tape drive, etc.). The storage 2206 may comprise an internal storage device or an attached or network accessible storage. Programs, including an operating system 2208 and applications 2210 stored in the storage 2206 are loaded into the memory 2204 and executed by the processor 2202. The applications 2210 may include the described manager 114, its components 116, 118, 120, 120 and other program components described above. The architecture 2200 further includes a network card 2212 to enable communication with the network 16. An input device 2214 is used to provide user input to the processor 2202, and may include a keyboard, mouse, pen-stylus, microphone, touch sensitive display screen, or any other activation or input mechanism known in the art. An output device 2216, such as a display monitor, printer, storage, etc., is capable of rendering information transmitted from a graphics card or other component. The output device 2216 may render the GUIs described with respect to figures and the input device 2214 may be used to interact with the graphical controls and elements in the GUIs described above. The architecture 2200 may be implemented in any number of computing devices, such as a server, mainframe, desktop computer, laptop computer, hand held computer, tablet computer, personal digital assistant (PDA), telephony device, cell phone, etc.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

The use of variable references, such as “a”, “n”, etc., to denote a number of instances of an item may refer to any integer number of instances of the item, where different variables may comprise the same number or different numbers. Further, a same variable reference used with different elements may denote a same or different number of instances of those elements.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The illustrated operations of the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer program product for implementing a reservation of a rental property between a renter of the rental property and a property manager of the property through communication with a renter computer and a property manager computer, wherein the computer program product comprises a computer readable storage medium having code that when executed to perform operations, the operations comprising:
storing in a computer implemented property reservation service database information on rental properties each having at least one unit to lease at the property;
storing in the property reservation service database a hold amount, a cancellation period and an authorization hold period defined for an authorization hold, wherein the authorization hold period is greater than the cancellation period and runs following the cancellation period; and
receiving from the renter computer a reservation request for a reserved property comprising one of the properties at which the renter seeks to lease a unit at the reserved property and information on a renter financial account, wherein the reservation request occurs before the lease of the property is signed; and
initiating at least one online electronic transaction to place an authorization hold of the hold amount on the renter financial account for the reserved property in response to the reservation request, wherein the authorization hold maintains the hold amount as unavailable in the renter financial account.

2. The computer program product, of claim 1 wherein the initiating the at least online transaction to place the authorization hold comprises:
initiating a plurality of online transactions with an acquirer computer system to place an acquirer authorization hold for an acquirer authorization hold period on the renter financial account, wherein the authorization hold period is a multiple of the acquirer authorization hold period.

3. The computer program product of claim 2, wherein there is an interval between each of the plurality of initiated online transactions with the acquirer computer system, wherein the interval is less than the acquirer authorization hold period.

4. The computer program product of claim 1, wherein the operations further comprise:
releasing the authorization hold from the renter financial account in response to the renter computer requesting cancellation of the reservation prior to an expiration of the cancellation period from a reservation time; and
initiating an online transaction to transfer the hold amount from the renter financial account to a property manager financial account in response to receiving a cancellation request from the property manager computer between the expiration of the cancellation period and before an expiration of the authorization hold period from the reservation time.

5. The computer program product of claim 1, wherein the computer program is implemented within an online property reservation service provider server, wherein the online transaction comprises a first online transaction, wherein in response to the reservation request, the operations further comprise:
initiating a second online transaction to transfer a first fee which is less than the hold amount from the renter financial account to the property manager financial account; and
initiating a third online transaction to transfer a second fee to property reservation service provider account of the property reservation service provider maintaining the online property reservation service provider server.

6. The computer program product of claim 1, wherein the operations further comprise:
releasing the authorization hold from the renter financial account in response to receiving no cancellation from the renter computer within the cancellation period and receiving no cancellation from the property manager computer between the expiration of the cancellation period and the expiration of the authorization hold period.

7. The computer program product of claim 1, wherein the operations further comprise:
providing a release code for each of the properties in the property reservation service database; and
releasing the authorization hold from the renter financial account in response to receiving from the property manager or the renter the release code for the reserved property between the expiration of the cancellation period and the expiration of the authorization hold period.

8. The computer program product of claim 1, wherein the operations further comprise:
receiving from the renter computer a request for information with respect to the reserved property;
in response to the request for information before the expiration of the cancellation period, coding in a computer renderable page a user selectable graphical element that when invoked at the renter computer causes cancellation of the authorization hold on the renter financial account; and
transmitting the computer renderable page to the renter computer.

9. The computer program product of claim 1, wherein the operations further comprise:
maintaining for the reserved property, in the property reservation service database, information on a number of leasable units at the reserved property, a number of leased units at the reserved property, and a number of pending authorization holds on the reserved property; and
in response to receiving the reservation request, determining whether there are available units at the reserved property, wherein there are available units when the number of leasable units exceeds the number of pending authorization holds on the reserved property, wherein the initiating of the online electronic transaction to place the authorization hold is performed when there are available units.

10. The computer program product of claim 9, wherein the operations further comprise:
generating a computer renderable page including a graphical element that when invoked at the renter computer causes the renter computer to transmit a wait list request to be added to a wait list in response to determining that there are no available units;
adding the renter to the wait list maintained in the property reservation service database in response to receiving the wait list request to be added to the wait lists; and
initiating an online electronic transaction to place an authorization hold of the hold amount on the renter financial account in response to the renter reaching a top of the wait list when at least one of the units is available.

11. The computer program product of claim 1, wherein more authorization holds may be placed on renter financial accounts for a reserved property than a number of available units at the property.

12. The computer program product of claim 1, wherein the operations further comprise:
transmitting to the property manager computer a computer renderable page identifying a selectable list of the renters that sent the reservation request; and
receiving from the property manager computer selection from the computer renderable page to perform one of release the hold before the cancellation period or the authorization hold period has expired and bank the hold to transfer the hold amount charged to the renter financial account following expiration of the cancellation period and before expiration of the authorization hold period.

13. The computer program product of claim 12, wherein the operations further comprise:
coding in the computer renderable page a first graphical element to enable invocation of a first electronic transaction to release the hold for renters indicated in the selectable list for which the cancellation period has expired; and
coding in the computer renderable page a second graphical element to enable invocation of a second electronic transaction to bank the hold for the renters indicated in the selectable list for which the cancellation period has expired and the authorization hold period has not expired.

14. The computer program product of claim 1, wherein the operations further comprise:
in response to receiving the reservation request, transmitting a first computer renderable page coded to enable the renter to indicate a rating of characteristics of the reserved property at the renter computer;
storing the received rating of the characteristics of the reserved property in the property reservation service database to use to generate cumulative user ratings for the reserved property from multiple renters who transmitted the reservation request for the reserved property; and
transmitting a second page to the property manager computer coded to enable the property manager to select reviews for the reserved property in the property reservation service database to suppress so as not to be presented to users requesting information on the reserved property.

15. The computer program product of claim 14, wherein the operations further comprise:
receiving a request for rating information for the reserved property; and
in response to the request, generating a third page indicating a cumulative review for the reserved property comprising an aggregation of individual reviews from renters in the property reservation service database that are not indicated as suppressed, wherein the aggregation of the individual reviews provides greater weight to more recent reviews.

16. A system for implementing a reservation of a rental property between a renter of the rental property and a property manager of the property through communication with a renter computer and a property manager computer, comprising:
a processor; and
a computer readable storage medium including computer code executed by the processor to perform operations, the operations comprising:
storing in a computer implemented property reservation service database information on rental properties each having at least one unit to lease at the property;
storing in the property reservation service database a hold amount, a cancellation period and an authorization hold period defined for an authorization hold, wherein the authorization hold period is greater than the cancellation period and runs following the cancellation period; and
receiving from the renter computer a reservation request for a reserved property comprising one of the properties at which the renter seeks to lease a unit at the reserved property and information on a renter financial account, wherein the reservation request occurs before the lease of the property is signed; and
initiating at least one online electronic transaction to place an authorization hold of the hold amount on the renter financial account for the reserved property in response to the reservation request, wherein the authorization hold maintains the hold amount as unavailable in the renter financial account.

17. The system of claim 16, wherein the initiating the at least online transaction to place the authorization hold comprises:
initiating a plurality of online transactions with an acquirer computer system to place an acquirer authorization hold for an acquirer authorization hold period on the renter financial account, wherein the authorization hold period is a multiple of the acquirer authorization hold period.

18. The system of claim 16, wherein the operations further comprise:
transmitting to the property manager computer a computer renderable page identifying a selectable list of the renters that sent the reservation request; and
receiving from the property manager computer selection from the computer renderable page to perform one of release the hold before the cancellation period or the authorization hold period has expired and bank the hold to transfer the hold amount charged to the renter financial account following expiration of the cancellation period and before expiration of the authorization hold period.

19. A computer implemented method for implementing a reservation of a rental property between a renter of the rental property and a property manager of the property through communication with a renter computer and a property manager computer, comprising:
storing in a computer implemented property reservation service database information on rental properties each having at least one unit to lease at the property;
storing in the property reservation service database a hold amount, a cancellation period and an authorization hold period defined for an authorization hold, wherein the authorization hold period is greater than the cancellation period and runs following the cancellation period; and
receiving from the renter computer a reservation request for a reserved property comprising one of the properties at which the renter seeks to lease a unit at the reserved property and information on a renter financial account, wherein the reservation request occurs before the lease of the property is signed; and
initiating at least one online electronic transaction to place an authorization hold of the hold amount on the renter financial account for the reserved property in response to the reservation request, wherein the authorization hold maintains the hold amount as unavailable in the renter financial account.

20. The method of claim 19, wherein the initiating the at least online transaction to place the authorization hold comprises:
initiating a plurality of online transactions with an acquirer computer system to place an acquirer authorization hold for an acquirer authorization hold period on the renter financial account, wherein the authorization hold period is a multiple of the acquirer authorization hold period.

21. The method of claim 19, further comprising:
transmitting to the property manager computer a computer renderable page identifying a selectable list of the renters that sent the reservation request; and
receiving from the property manager computer selection from the computer renderable page to perform one of release the hold before the cancellation period or the authorization hold period has expired and bank the hold to transfer the hold amount charged to the renter financial account following expiration of the cancellation period and before expiration of the authorization hold period.
